(19) United States
(12) Patent Application Publication
(10) Pub. No.: US 2026/0237926 A1
(43) Pub. Date: Aug. 13, 2026

(54) CONNECTOR DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Akihiro NISHITANI, Mie (JP)

(21) Appl. No.: 19/470,816

(22) PCT Filed: Mar. 18, 2024
(86) PCT No.: PCT/JP2024/010469

§ 371 Date: Sep. 30, 2025

(30) Foreign Application Priority Data
Apr. 5, 2023 (JP) 2023-061637

(51) Int. Cl. H01R 12/73

(52) U.S. Cl. CPC H01R 12/737

(57) ABSTRACT

The present invention achieves size reduction in a direction parallel to a second circuit board. This connector device comprises: a first circuit board (10); a first housing (16); a first terminal fitting (25) attached to the first housing (16); a second circuit board (40) disposed at a right angle to the first circuit board (10); a second housing (46); and a second terminal fitting (55) attached to the second housing (46). A second terminal connection part (56) of the second terminal fitting (55) and a second board connection part (62) are arranged so as to be aligned in a direction perpendicular to the second circuit board (40). The first terminal connection part (26) is accommodated in the first housing (16). A cut-out part (23) for avoiding interference with the second terminal fitting (55) is formed in a bottom wall part (22) constituting the first housing (16).

### TECHNICAL FIELD

The present disclosure relates to a connector device.

### BACKGROUND

Patent Document 1 discloses a board-to-board connector including a first board and a second board arranged at a right angle to each other, a first terminal of a first connector mounted on the first board and a second terminal of a second connector mounted on the second board.

### PRIOR ART DOCUMENT

### Patent Document

Patent Document 1: JP 2011-090856 A

### SUMMARY OF THE INVENTION

### Problems to be Solved

The first terminal includes a solder tail portion to be fixed to the first board by welding and a contact portion for contacting the second terminal. The solder tail portion and the contact portion are arranged in such a positional relationship as to be separated in a direction parallel to the first board. Thus, the first connector including the first terminal is enlarged in the direction parallel to the first board.

A connector device of the present disclosure was completed on the basis of the above situation and aims to realize a size reduction in a direction parallel to a circuit board.

### Means to Solve the Problem

The present disclosure is directed to a connector device with a first circuit board, a first housing, a first terminal fitting including a first terminal connecting portion and a first board connecting portion fixed to the first circuit board, the first terminal fitting being mounted in the first housing, a second circuit board arranged at a right angle to the first circuit board, a second housing connectable to the first housing, and a second terminal fitting including a second terminal connecting portion capable of contacting the first terminal connecting portion and a second board connecting portion fixed to the second circuit board, the second terminal fitting being mounted in the second housing, the second terminal connecting portion and the second board connecting portion being arranged side by side in a direction intersecting the second circuit board, the first terminal connecting portion being accommodated in the first housing, and a wall portion constituting the first housing being formed with a cut portion for avoiding interference with the second terminal fitting.

### Effect of the Invention

The connector device of the present disclosure can realize a size reduction in a direction parallel to the second circuit board.

### BRIEF DESCRIPTION OF THE DRAWINGS

FIG. 1 is a perspective view of a connector device of one embodiment.

FIG. 2 is a perspective view showing a state where a first connector is mounted on a first circuit board.

FIG. 3 is an exploded perspective view of the first connector.

FIG. 4 is a plan view in section of the first connector.

FIG. 5 is a perspective view of a second connector.

FIG. 6 is an exploded perspective view of the second connector.

FIG. 7 is a front view in section of the second connector.

FIG. 8 is a side view in section showing a state where the first and second connectors are separated.

FIG. 9 is a side view in section showing a state where the first and second connectors are connected.

### DETAILED DESCRIPTION TO EXECUTE THE INVENTION

### Description of Embodiments of Present Disclosure

First, embodiments of the present disclosure are listed and described. Arbitrary combinations of a plurality of embodiments below without causing any contradiction are also included in embodiments for carrying out the invention.
(1) The connector device of the present disclosure is provided with a first circuit board, a first housing, a first terminal fitting including a first terminal connecting portion and a first board connecting portion fixed to the first circuit board, the first terminal fitting being mounted in the first housing, a second circuit board arranged at a right angle to the first circuit board, a second housing connectable to the first housing, and a second terminal fitting including a second terminal connecting portion capable of contacting the first terminal connecting portion and a second board connecting portion fixed to the second circuit board, the second terminal fitting being mounted in the second housing. The second terminal connecting portion and the second board connecting portion are arranged side by side in a direction intersecting the second circuit board. The first terminal connecting portion is accommodated in the first housing. A wall portion constituting the first housing is formed with a cut portion for avoiding interference with the second terminal fitting.

According to this configuration, with the first and second housings connected to connect the first and second terminal connecting portions, the second board connecting portion is arranged side by side with a contact region of the first and second terminal connecting portions in the direction intersecting the second circuit board. In this way, a size reduction can be realized in a direction parallel to the second circuit board.
(2) Preferably in (1), the second terminal fitting is fit to approach the first terminal fitting in a direction intersecting the first circuit board, and the second housing is formed with a supporting wall portion for receiving a pressing force at the time of fitting applied from the first terminal fitting to the second terminal fitting. According to this configuration, even if the second terminal fitting receives a pressing force from the first terminal fitting at the time of fitting the first and second terminal fittings, a relative displacement of the second terminal fitting with respect to the first terminal fitting can be prevented.
(3) Preferably in (1) or (2), the second housing is box-shaped to surround the first housing, and a facing wall portion facing the second circuit board in the second housing is formed with a recess for exposing a connected part of the second board connecting portion to the second circuit board to outside of the second housing. According to this configuration, a connected state of the second board connecting portion and the second circuit board can be visually confirmed.
(4) Preferably in (1) or (2), the second terminal fitting is fit to approach the first terminal fitting in a direction intersecting the first circuit board, the second board connecting portion is surface-mounted on the second circuit board, and the second board connecting portion includes an extending portion projecting further toward the first circuit board than the second terminal connecting portion. According to this configuration, since a long joint length of the second board connecting portion with the second circuit board can be ensured in a fitting direction of the first terminal connecting portion to the second terminal connecting portion, the second terminal fitting can be reliably fixed to the second circuit board even if a pressing force is applied from the first terminal fitting to the second terminal fitting at the time of connecting the first and second terminal connecting portions.
(5) Preferably in (1) or (2), a pair of the first terminal fittings are arranged side by side in parallel to the first circuit board, the first board connecting portion includes a first bent portion having a quarter arc shape and extending from the first terminal connecting portion and a first mounting portion extending in parallel to the first circuit board from the first bent portion, and extension directions of a pair of the first mounting portions are directions opposite to each other along an arrangement direction of the pair of first terminal fittings. According to this configuration, a long creepage distance between a pair of the first mounting portions can be ensured on the mounting surface of the first circuit board.
(6) Preferably in (1) or (2), a pair of the second terminal fittings are arranged side by side in parallel to the second circuit board, the second board connecting portion includes a second bent portion having a quarter arc shape and extending from the second terminal connecting portion and a second mounting portion extending in parallel to the second circuit board from the second bent portion, and extension directions of a pair of the second mounting portions are directions opposite to each other along an arrangement direction of the pair of second terminal fittings. According to this configuration, a long creepage distance between a pair of the second mounting portions can be ensured on the mounting surface of the second circuit board.
(7) Preferably in (1) or (2), the second terminal fitting is mounted by press-fitting the second terminal connecting portion into the second housing, the second terminal connecting portion includes two folded and bent plate-like portions, one of the two plate-like portions is linked to the second board connecting portion, and a pressure receiving surface for receiving a pressing force for press-fitting the second terminal fitting into the second housing is formed on an end surface of the other of the two plate-like portions. According to this configuration, the strength of the second terminal connecting portion can be enhanced by folding the second terminal connecting portion. Further, since the pressure receiving surface for receiving a pressing force at the time of press-fitting is ensured by having a folded shape, the pressing force needs not be applied to the second board connecting portion. In this way, the second terminal fitting can be press-fit into the second housing without deforming or damaging the second board connecting portion.

### Details of Embodiment of Present Disclosure

### Embodiment

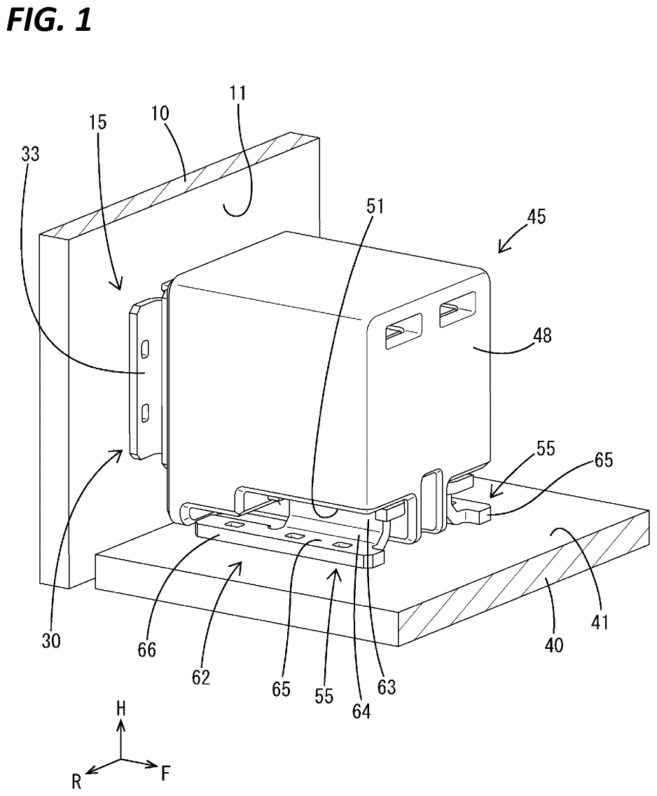

A connector device of one specific embodiment of the present disclosure is described below with reference to FIGS. 1 to 9. The present invention is not limited to these illustrations, but is represented by claims and intended to include all changes in the scope of claims and in the meaning and scope of equivalents. In this embodiment, a direction F in FIGS. 1 to 6, 8 and 9 is defined as a forward direction concerning a front-rear direction. A direction H in FIGS. 1 to 3 and 5 to 9 is defined as an upward direction concerning a vertical direction. A direction R in FIGS. 1 to 7 is defined as a rightward direction concerning a lateral direction. The lateral direction and a width direction are used as synonyms.

A connector device of this embodiment is provided with a first circuit board 10, a first connector 15 mounted on a first mounting surface 11 of the first circuit board 10, a second circuit board 40 and a second connector 45 mounted on a second mounting surface 41 of the second circuit board 40.

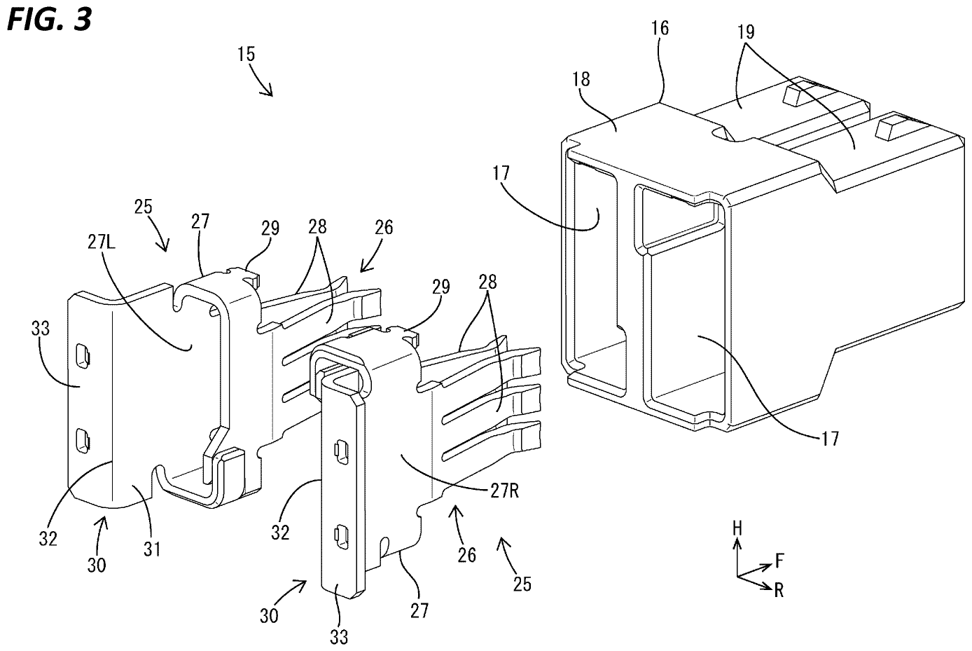

As shown in FIGS. 1, 2 and 4, the first circuit board 10 is so arranged that a plate thickness direction is oriented in the front-rear direction and the first mounting surface 11 is facing forward. As shown in FIG. 3, the first connector 15 is provided with a first housing 16 and a pair of first terminal fittings 25. A pair of left and right first terminal accommodation chambers 17 open on both front and rear ends are formed in the first housing 16. The first housing 16 includes one rear accommodating portion 18 and a pair of left and right front accommodating portions 19. The rear accommodating portion 18 constitutes rear end regions of the both left and right first terminal accommodation chambers 17. The front accommodating portions 19 extend forward from the front end of the rear accommodating portion 18. The pair of front accommodating portions 19 individually constitute front end regions of the pair of first terminal accommodation chambers 17. The front accommodating portion 19 is in the form of a rectangular tube having a height larger than a width.

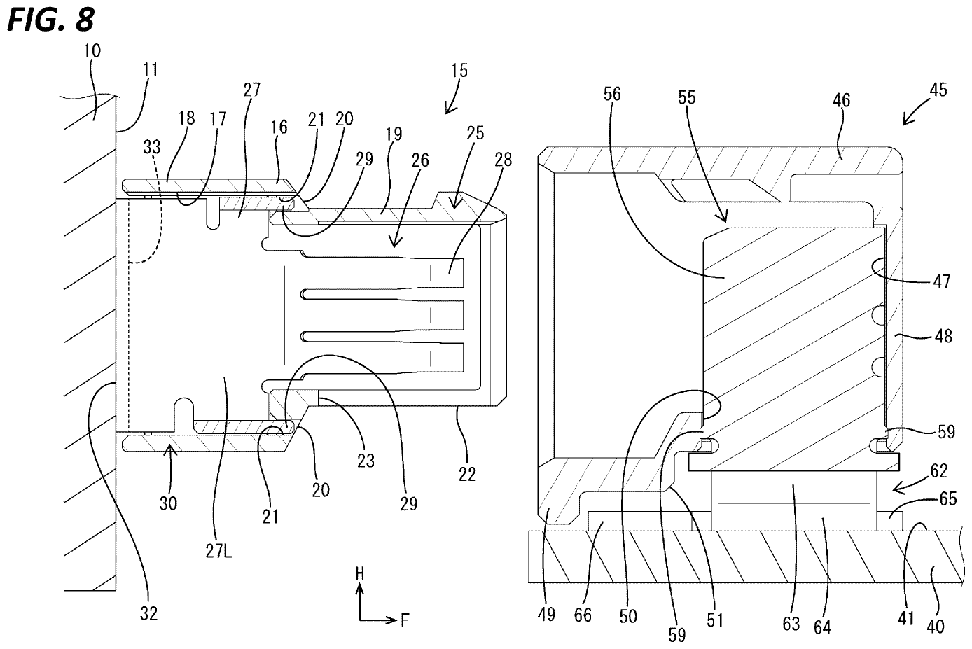

A vertical dimension of the rear accommodating portion 18 is larger than those of the front accommodating portions 19. As shown in FIG. 8, an inclined wall portion 20 is formed between the front end of an upper wall portion of the rear accommodating portion 18 and the rear ends of upper wall portions of the front accommodating portions 19. An inclined wall portion 20 is also formed between the front end of a lower wall portion of the rear accommodating portion 18 and the rear ends of lower wall portions of the front accommodating portions 19. A pair of left and right first press-fitting holes 21 are formed in the inclined wall portion 20. The rear end of the first press-fitting hole 21 is open in an upper end part of the first terminal accommodation chamber 17.

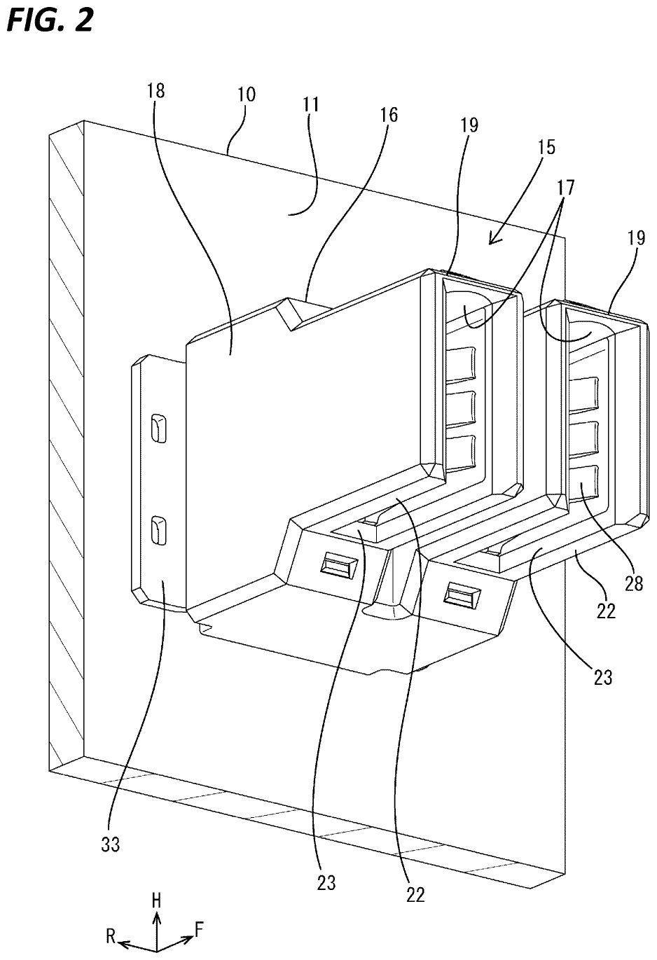

As shown in FIGS. 2, 8 and 9, bottom wall portions 22 constituting the both left and right front accommodating portions 19 are formed with cut portions 23 extending in the front-rear direction (direction orthogonal to the first mounting surface 11 of the first circuit board 10). The cut portion 23 is open in the front, upper and lower surfaces of the bottom wall portion 22. The cut portion 23 allows communication between the front end region of the first terminal accommodation chamber 17 and a lower space outside the first housing 16. The cut portion 23 is open forward of the first housing 16.

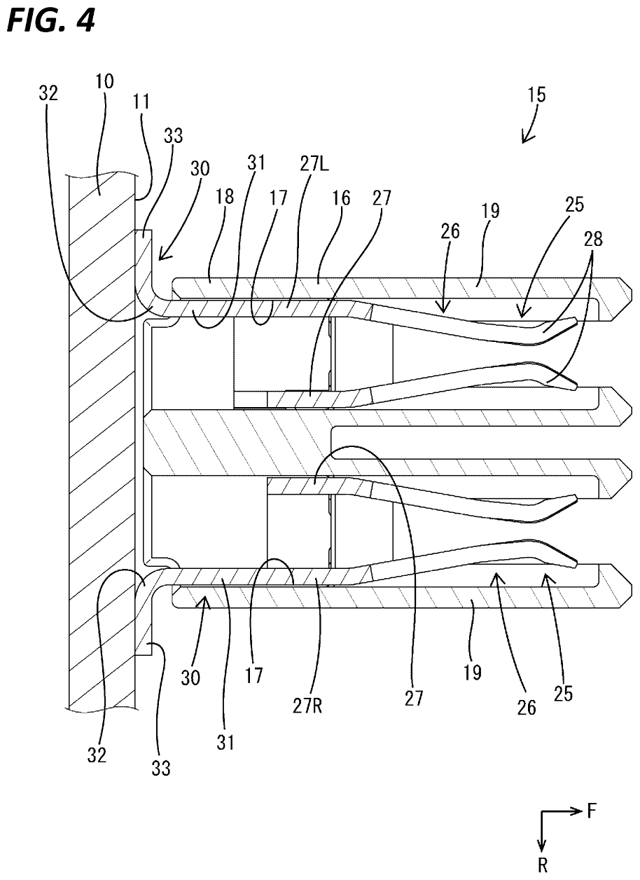

The first terminal fitting 25 is a single female component formed of a bent metal plate material. As shown in FIGS. 3 and 4, the first terminal fitting 25 includes a first terminal connecting portion 26 and a first board connecting portion 30. The first board connecting portion 30 extends rearward from the first terminal connecting portion 26. The first terminal connecting portion 26 and the first board connecting portion 30 are located side by side in a direction orthogonal to the first mounting surface 11. The first terminal connecting portion 26 includes a supporting portion 27 in the form of a rectangular tube open on both front and rear ends and a pair of left and right resilient contact pieces 28. The pair of resilient contact pieces 28 are cantilevered forward from the front end edges of both left and right side plate portions constituting the supporting portion 27. As shown in FIGS. 3 and 8, first press-fitting projections 29 projecting forward are formed on upper and lower plate portions constituting the supporting portion 27.

The first board connecting portion 30 of the first terminal fitting 25 arranged on a right side extends rearward from the rear end edge of a right side plate portion 27R, out of four plate portions constituting the supporting portion 27. The first board connecting portion 30 includes a first plate-like base portion 31, a first bent portion 32 and a first mounting portion 33. The first plate-like base portion 31 is continuous and flush with the right side plate portion 27R and extends rearward from the rear end edge of the right side plate portion 27R. The first bent portion 32 has a quarter arc shape and extends obliquely to a right rear side from the rear end edge of the first plate-like base portion 31. The first mounting portion 33 extends rightward at a right angle to the first plate-like base portion 31 from the extending end edge of the first bent portion 31. In the first terminal fitting 25 on the right side, the first mounting portion 33 is arranged in a right end part most distant from the first terminal fitting 25 on a left side, out of the supporting portion 27. In the first terminal fitting 25 on the right side, an extension direction of the first mounting portion 33 is a direction away from the first terminal fitting 25 on the left side.

The first board connecting portion 30 of the first terminal fitting 25 arranged on the left side extends rearward from the rear end edge of a left side plate portion 27L, out of the four plate portions constituting the supporting portion 27. The first board connecting portion 30 includes a first plate-like base portion 31, a first bent portion 32 and a first mounting portion 33. The first plate-like base portion 31 is continuous and flush with the left side plate portion 27L and extends rearward from the rear end edge of the left side plate portion 27L. The first bent portion 32 has a quarter arc shape and extends obliquely to a left rear side from the rear end edge of the first plate-like base portion 31. The first mounting portion 33 extends leftward at a right angle to the first plate-like base portion 31 from the extending end edge of the first bent portion 31. In the first terminal fitting 25 on the left side, the first mounting portion 33 is arranged in a left end part most distant from the first terminal fitting 25 on the right side, out of the supporting portion 27. In the first terminal fitting 25 on the left side, an extension direction of the first mounting portion 33 is a direction away from the first terminal fitting 25 on the right side.

The both left and right first terminal fittings 25 are individually accommodated in the pair of first accommodation chambers 17 from behind the first housing 16. The first terminal fittings 25 accommodated in the first terminal accommodation chambers 17 are held in the first housing 16 by causing the pair of upper and lower first projections 29 to bite into the inner surfaces of the first press-fitting holes 21. The assembly of the first connector 15 is completed by accommodating the first terminal fittings 25 into the first housing 16 as described above. With the first terminal fitting 25 mounted in the first housing 16, the first plate-like base portion 31 of the first board connecting portion 30 and the supporting portion 27 of the first terminal connecting portion 26 are arranged in the rear end region of the first terminal accommodation chamber 17. The resilient contact pieces 28 are arranged in the front end region of the first terminal accommodation chamber 17. The resilient contact pieces 28 are arranged in the same region as the cut portion 23 in the front-rear direction (direction parallel to the second mounting surface 41 of the second circuit board 40).

The first connector 15 is mounted on the surface of the first circuit board 10 with the openings on the rear ends of the first terminal accommodation chambers 17 facing toward the first circuit board 10. The first connector 15 is mounted by conductively fixing the first mounting portions 33 to the first mounting surface 11 by reflow soldering.

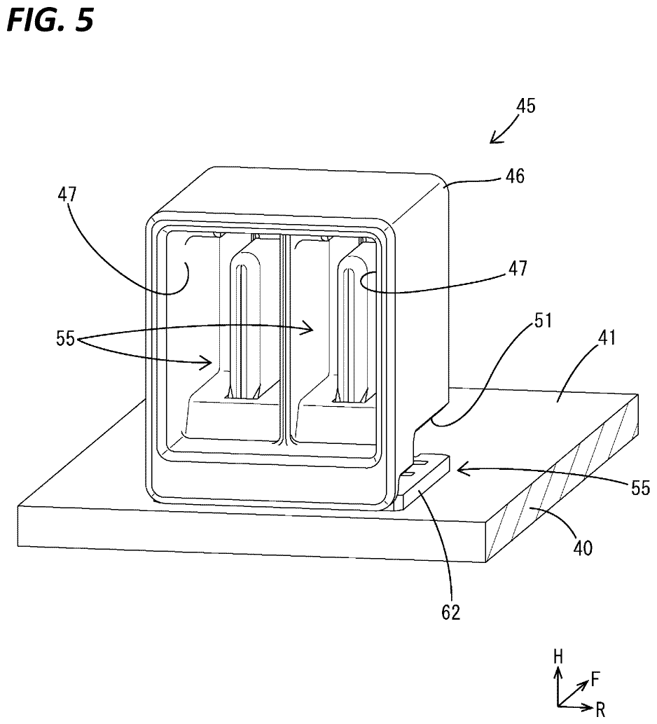

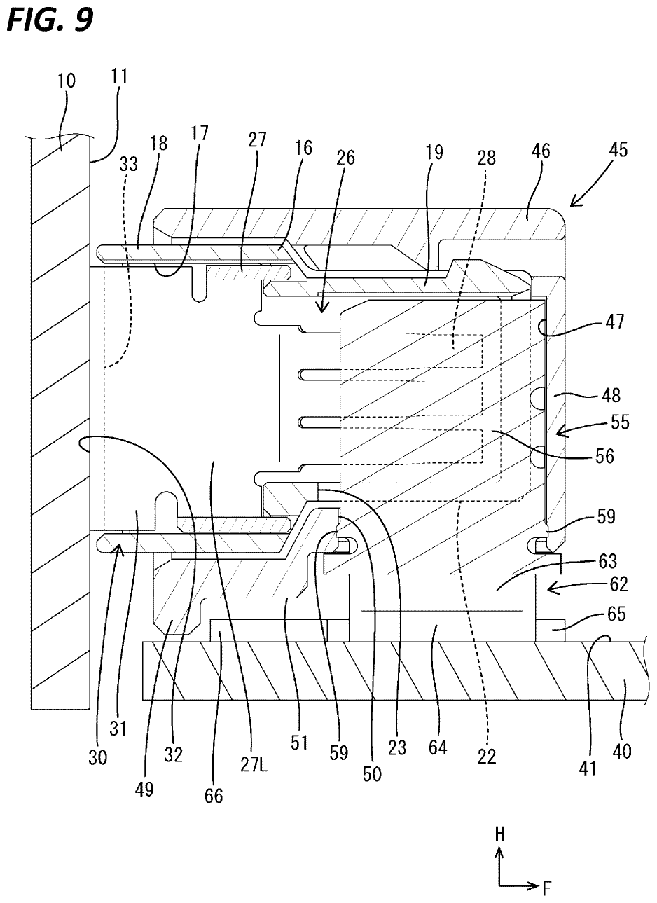

The second circuit board 40 is arranged below the first connector 15 with a plate thickness direction oriented in the vertical direction and the second mounting surface 41 facing upward. The second mounting portion 41 is at a right angle to the first mounting surface 11. As shown in FIGS. 5 to 7, the second connector 45 is provided with a second housing 46 and a pair of bilaterally symmetrical second terminal fittings 55. A pair of left and right second terminal accommodation chambers 47 having open rear ends are formed in the second housing 46. As shown in FIG. 5, in a back view of the first housing 16 from behind, the second terminal accommodation chambers 47 have a rectangular shape having a height larger than a width. As shown in FIGS. 8 and 9, the second housing 46 includes a supporting wall portion 48 closing the front ends of the both left and right second terminal accommodation chambers 47.

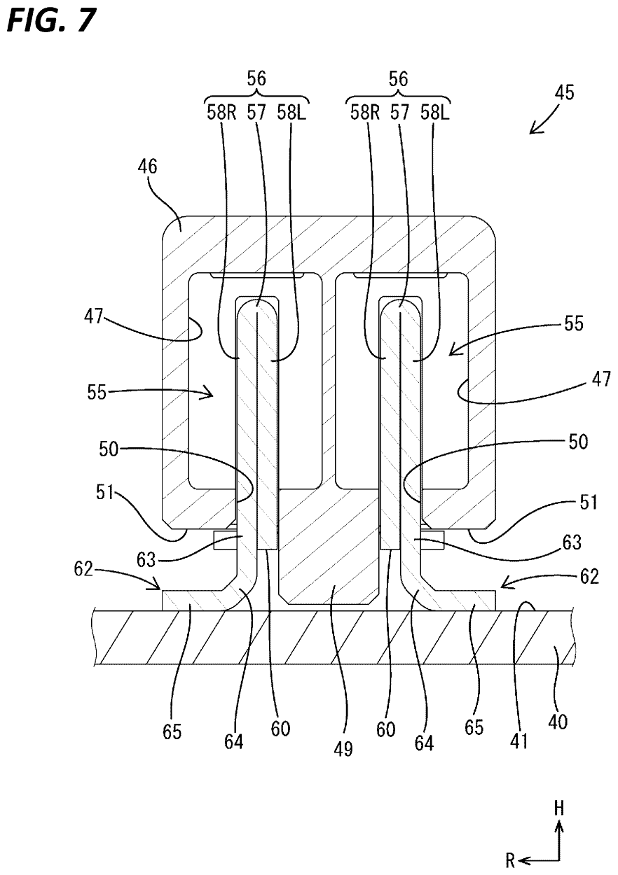

As shown in FIGS. 7 to 9, out of outer wall portions constituting the second housing 46, a facing wall portion 49 on the lower surface facing the second mounting surface 41 is formed with a pair of left and right second press-fitting holes 50. The second press-fitting hole 50 is shaped to be elongated in the front-rear direction and open in the upper and lower surfaces of the facing wall portion 49. The second press-fitting hole 50 allows communication between the second terminal accommodation chamber 47 and a lower space outside the second housing 46. The facing wall portion 49 is formed with a pair of left and right recesses 51 by recessing parts of the facing wall portion 49. The right recess 51 is open in the right side surface and the front surface of the second housing 46. The left recess 51 is open in the left side surface and the front surface of the second housing 46. In a bottom view of the second housing 46 from below (side of the second circuit board 40), the second press-fitting hole 50 is arranged in the recess 51.

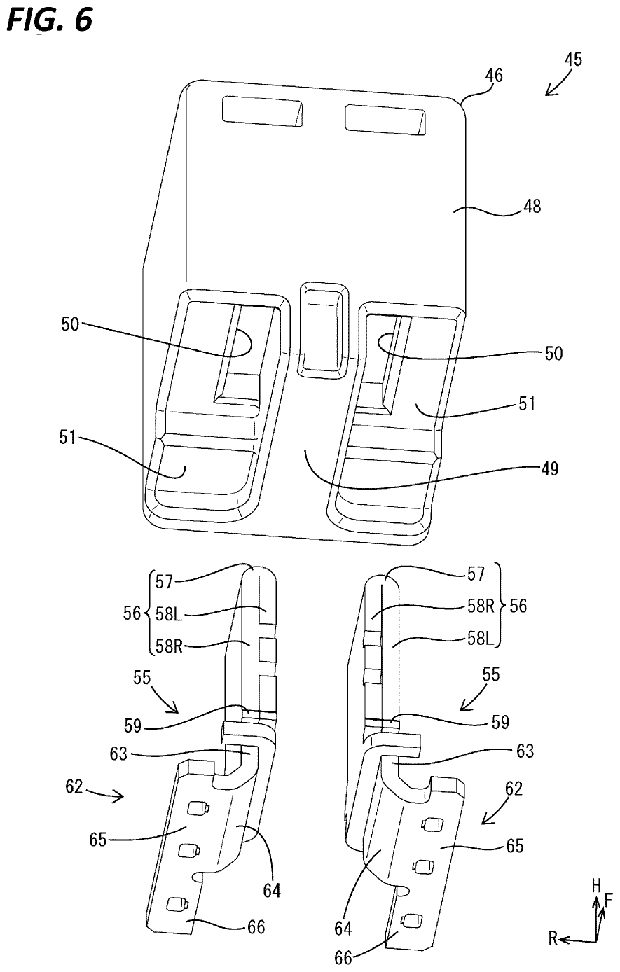

The second terminal fitting 55 is a single male component formed of a bent metal plate material. The second terminal fitting 55 includes a second terminal connecting portion 56 and a second board connecting portion 62. The second board connecting portion 62 extends downward from the first terminal connecting portion 26. The second terminal connecting portion 56 and the second board connecting portion 62 are located side by side in a direction orthogonal to the second mounting surface 41. As shown in FIGS. 6 and 7, the second terminal connecting portion 56 includes a folded portion 57 and a pair of left and right plate-like portions 58L, 58R extending downward from the folded portion 57 in parallel to each other. As shown in FIGS. 8 and 9, second press-fitting projections 59 projecting forward are formed on front end parts of lower end parts of the both left and right plate-like portions 58L, 58R. Second press-fitting projections 59 projecting rearward are formed on rear end parts of the lower end parts of the both left and right plate-like portions 58L, 58R.

As shown in FIG. 7, out of a pair of the plate-like portions 58L, 58R of the second terminal fitting 55 arranged on the right side, the lower end surface of the left plate-like portion 58L functions as a pressure receiving surface 60. Out of a pair of the plate-like portions 58L, 58R of the second terminal fitting 55 arranged on the left side, the lower end surface of the right plate-like portion 58R also functions as a pressure receiving surface 60. These pressure receiving surfaces 60 are surfaces for receiving a pressing force in a press-fitting direction from a jig or the like when the second terminal fitting 55 is press-fit into the second press-fitting hole 50.

As shown in FIGS. 6 and 7, the second board connecting portion 62 of the second terminal fitting 55 arranged on the right side extends downward from the lower end edge of the right plate-like portion 58R, out of the pair of left and right plate-like portions 58L, 58R. The second board connecting portion 62 includes a second plate-like base portion 63, a second bent portion 64 and a second mounting portion 65. The second plate-like base portion 63 is continuous and flush with the right plate-like portion 58R and extends downward from the lower end edge of the right plate-like portion 58R. The second bent portion 64 has a quarter arc shape and extends obliquely to a right lower side from the lower end edge of the second plate-like base portion 63. The second mounting portion 65 extends rightward at a right angle to the plate-like portion 58R from the extending end edge of the second bent portion 64. In the second terminal fitting 25 on the right side, the second mounting portion 65 is arranged in a right end part most distant from the second terminal fitting 55 on the left side, out of the second board connecting portion 62. In the second terminal fitting 25 on the right side, an extension direction of the second mounting portion 65 is a direction away from the second terminal fitting 55 on the left side. The second mounting portion 65 includes an extending portion 66 extending further rearward than the rear ends of the second plate-like base portion 63 and the second bent portion 64.

The second board connecting portion 62 of the second terminal fitting 55 arranged on the left side extends downward from the lower end edge of the left plate-like portion 58L, out of the pair of left and right plate-like portions 58L, 58R. The second board connecting portion 62 includes a second plate-like base portion 63, a second bent portion 64 and a second mounting portion 65. The second plate-like base portion 63 is continuous and flush with the left plate-like portion 58L and extends downward from the lower end edge of the left plate-like portion 58L. The second bent portion 64 has a quarter arc shape and extends obliquely to a left lower side from the lower end edge of the second plate-like base portion 63. The second mounting portion 65 extends leftward at a right angle to the second plate-like base portion 63 from the extending end edge of the second bent portion 64. In the second terminal fitting 55 on the left side, the second mounting portion 65 is arranged in a left end part most distant from the second terminal fitting 55 on the right side, out of the second board connecting portion 62. In the second terminal fitting 55 on the left side, an extension direction of the second mounting portion 65 is a direction away from the second terminal fitting 55 on the right side. As shown in FIGS. 1, 6, 8 and 9, the second mounting portion 65 includes an extending portion 66 extending further rearward than the rear ends of the second plate-like base portion 63 and the second bent portion 64.

The both left and right second terminal fittings 55 are mounted into the second housing 46 by press-fitting the second terminal connecting portions 56 into the second press-fitting holes 50 from below the second housing 46. At the time of press-fitting, the pressure receiving surfaces 60 of the second terminal connecting portions 56 are pressed by a jig (not shown). The second terminal fittings 55 mounted in the second housing 46 are held in the second housing 46 by causing the pair of front and rear second projections 59 to bite into the inner surfaces of the second press-fitting holes 50. The assembly of the second connector 45 is completed by mounting the second terminal fittings 55 into the second housing 46 as described above. With the second terminal fitting 55 mounted in the second housing 46, the second terminal connecting portion 56 is accommodated in the second terminal accommodation chamber 47 and the second board connecting portion 62 is arranged in the recess 51.

The second connector 45 is mounted on the surface of the second circuit board 40 with the recesses 51 (facing wall portion 49) of the second housing 46 facing toward the second circuit board 40. The second connector 45 is mounted by conductively fixing the second mounting portions 65 to the second mounting surface 41 by reflow soldering.

When the first and second connectors 15, 45 are connected, the second circuit board 40 is parallelly moved rearward with respect to the first circuit board 10 and the first housing 16 is accommodated into the second housing 46. With the both connectors 15, 45 connected, the pair of left and right front accommodating portions 19 individually enter the pair of left and right second terminal accommodation chambers 47, and the resilient contact pieces 28 of the first terminal connecting portions 26 are resiliently contact the second terminal connecting portions 56 to sandwich the second terminal connecting portions 56 from the both left and right sides. Since the second board connecting portions 62 extend downward from the lower end parts of the second terminal connecting portions 56, there is a concern that the front accommodating portions 19 and the second terminal fittings 55 interfere. However, since the bottom wall portions 22 of the front accommodating portions 19 are formed with the cut portions 23 for accommodating the lower end parts of the second terminal connecting portions 56, the second terminal fittings 55 do not interfere with the front accommodating portions 19 (first housing 16).

Further, when the first and second terminal fittings 25, 55 are connected, a forward pressing force is applied to the second terminal fitting 55 from the side of the first terminal fitting 25 by friction resistance due to the resilience of the resilient contact pieces 28. However, since the front end edge of the second terminal connecting portion 56 is in contact with the supporting wall portion 48 of the second housing 46, the second terminal fitting 55 is neither inclined forward nor shifted in position with respect to the second housing 46.

The connector device of this embodiment is provided with the first circuit board 10, the first connector 15 mounted on the first circuit board 10, the second circuit board 40 arranged at a right angle to the first circuit board 10 and the second connector 45 mounted on the second circuit board 40. The first connector 15 is configured by mounting the first terminal fittings 25 into the first housing 16. The first terminal fitting 25 includes the first terminal connecting portion 26 and the first board connecting portion 30 fixed to the first circuit board 10. The second connector 45 is configured by mounting the second terminal fittings 55 connectable to the first terminal fittings 25 into the second housing 46 connectable to the first housing 16. The second terminal fitting 55 includes the second terminal connecting portion 56 to be connected to the first terminal connecting portion 26 and the second board connecting portion 62 fixed to the second circuit board 40.

The second terminal connecting portion 56 and the second board connecting portion 62 are arranged side by side in the vertical direction intersecting the second mounting surface 41 of the second circuit board 40. The first terminal connecting portions 26 are accommodated in the first housing 16. The bottom wall portions 22 constituting the first housing 16 are formed with the cut portions 23 for avoiding interference with the second terminal fittings 55. According to this configuration, with the first and second terminal connecting portions 26, 56 connected by connecting the first and second housings 16, 46, the second board connecting portion 62 is arranged side by side with a contact region of the first and second terminal connecting portions 26, 56 in the vertical direction intersecting the second circuit board 40. In this way, a size reduction can be realized in the front-rear direction and the lateral direction parallel to the second circuit board 40.

The second terminal fitting 55 is fit to approach the first terminal fitting 25 in the front-rear direction intersecting the first circuit board 10. The second housing 46 is formed with the supporting wall portion 48 for receiving pressing forces at the time of fitting applied to the second terminal fittings 55 from the first terminal fittings 25. According to this configuration, even if the second terminal fitting 55 receives the pressing force 25 when the first and second terminal connecting portions 26, 56 are fit, the second terminal fitting 55 can be prevented from being a relatively displaced forward with respect to the second housing 46.

The second housing 46 has a box shape to surround the first housing 16. In the second housing 46, the facing wall portion 49 facing the second circuit board 40 is formed with the recesses 51. The recesses 51 expose the second mounting portions 65, which are parts of the second board connecting portions 62 to be connected to the second circuit board 40, to the outside of the second housing 46. According to this configuration, a connected state of the second board connecting portions 62 and the second circuit board 40 can be visually confirmed from both left and right sides of or from behind the second housing 46.

The second terminal fitting 55 is fit to approach the first terminal fitting 25 in a direction intersecting the first circuit board 10. The second board connecting portion 62 is surface-mounted on the second circuit board 40. The second mounting portion 65 of the second board connecting portion 62 includes the extending portion 66 projecting further toward the first circuit board 10 (rearward) than the second terminal connecting portion 56. According to this configuration, in a fitting direction (front-rear direction) of the first terminal connecting portion 26 to the second terminal connecting portion 56, a long joint length of the second board connecting portion 62 with the second circuit board 40 can be ensured. In this way, the second terminal fitting 55 can be reliably fixed to the second circuit board 40 even if a pressing force in the front-rear direction is applied to the second terminal fitting 55 from the first terminal fitting 25 (resilient contact pieces 28) at the time of connecting the first and second terminal connecting portions 26, 56. The extending portion 66 extends toward the first circuit board 10, but the rear end of the extending portion 66 is located in front of the rear end of the second housing 46. Thus, the second connector 45 is not enlarged in the front-rear direction due to the formation of the extending portions 66.

The pair of first terminal fittings 25 are arranged side by side in the lateral direction, which is a direction parallel to the first circuit board 10. The first board connecting portion 30 includes the first bent portion 32 and the first mounting portion 33. The first bent portion 32 has a quarter arc shape and extends from the first terminal connecting portion 26 via the first plate-like base portion 31. The first mounting portion 33 extends from the first bent portion 32 in parallel to the first circuit board 10. Extension directions of the pair of first mounting portions 33 are opposite to each other along an arrangement direction (lateral direction) of the pair of first terminal fittings 25. According to this configuration, a long creepage distance between the pair of first mounting portions 33 can be ensured on the first mounting surface 11 of the first circuit board 10.

The pair of second terminal fittings 55 are arranged side by side in the lateral direction, which is a direction parallel to the second circuit board 40. The second board connecting portion 62 includes the second bent portion 64 and the second mounting portion 65. The second bent portion 64 has a quarter arc shape and extends from the second terminal connecting portion 56 via the second plate-like base portion 63. The second mounting portion 65 extends from the second bent portion 64 in parallel to the second circuit board 40. Extension directions of the pair of second mounting portions 65 are opposite to each other along an arrangement direction (lateral direction) of the pair of second terminal fittings 55. According to this configuration, a long creepage distance between the pair of second mounting portions 65 can be ensured on the second mounting surface 41 of the second circuit board 40.

The second terminal fitting 55 is mounted by press-fitting the second terminal connecting portion 56 into the second housing 46. The second terminal connecting portion 56 includes two folded and bent plate-like portions 58L, 58R. The second board connecting portion 62 is linked to one plate-like portion 58L, 58R of the two plate-like portions 58L, 58R. The pressure receiving surface 60, to which a pressing force for press-fitting the second terminal fitting 55 into the second housing 46 is applied, is formed on an end surface of the other plate-like portion 58L, 58R of the two plate-like portions 58L, 58R. According to this configuration, the strength of the second terminal connecting portion 56 can be enhanced by folding the second terminal connecting portion 56. Further, since the second terminal connecting portion 56 is ensured with the pressure receiving surface 60 for receiving a pressing force at the time of press-fitting by having a folded shape, a pressing force needs not be applied to the second board connecting portion 62. In this way, the second terminal fitting 55 can be press-fit into the second housing 46 without deforming or damaging the second board connecting portion 62.

### Other Embodiments

The present invention is not limited to the above described and illustrated embodiment, but is represented by claims. The present invention includes all changes in the scope of claims and in the meaning and scope of equivalents and also includes the following embodiments.

The first terminal fitting may be a male terminal, and the second terminal fitting may be a female terminal.

The second housing may be shaped not to include the supporting wall portion. A connected part of the second board connecting portion and the second circuit board may be accommodated in the second housing and invisible from outside.

The second board connecting portion and the second terminal connecting portion may have the same dimension in the fitting direction (direction orthogonal to the first circuit board) of the first and second terminal connecting portions.

The second terminal fitting may be mounted into the second housing by means other than press-fitting.

### LIST OF REFERENCE NUMERALS

10 . . . first circuit board
11 . . . first mounting surface
15 . . . first connector
16 . . . first housing
17 . . . first terminal accommodation chamber
18 . . . rear accommodating portion
19 . . . front accommodating portion
20 . . . inclined wall portion
21 . . . first press-fitting hole
22 . . . bottom wall portion (wall portion)
23 . . . cut portion
25 . . . first terminal fitting
26 . . . first terminal connecting portion
27 . . . supporting portion
27L . . . left side plate portion
27R . . . right side plate portion
28 . . . resilient contact piece
29 . . . first press-fitting projection
30 . . . first board connecting portion
31 . . . first plate-like base portion
32 . . . first bent portion
33 . . . first mounting portion
40 . . . second circuit board
41 . . . second mounting surface
45 . . . second connector
46 . . . second housing
47 . . . second terminal accommodation chamber
48 . . . supporting wall portion
49 . . . facing wall portion
50 . . . second press-fitting hole
51 . . . recess
55 . . . second terminal fitting
56 . . . second terminal connecting portion
57 . . . folded portion
58L . . . plate-like portion
58R . . . plate-like portion
59 . . . second press-fitting projection
60 . . . pressure receiving surface
62 . . . second board connecting portion
63 . . . second plate-like base portion
64 . . . second bent portion
65 . . . second mounting portion
66 . . . extending portion

1. A connector device, comprising:
a first circuit board;
a first housing;
a first terminal fitting including a first terminal connecting portion and a first board connecting portion fixed to the first circuit board, the first terminal fitting being mounted in the first housing;
a second circuit board arranged at a right angle to the first circuit board;
a second housing connectable to the first housing; and
a second terminal fitting including a second terminal connecting portion capable of contacting the first terminal connecting portion and a second board connecting portion fixed to the second circuit board, the second terminal fitting being mounted in the second housing,
the second terminal connecting portion and the second board connecting portion being arranged side by side in a direction intersecting the second circuit board,
the first terminal connecting portion being accommodated in the first housing, and
a wall portion constituting the first housing being formed with a cut portion for avoiding interference with the second terminal fitting.

2. The connector device of claim 1, wherein:
the second terminal fitting is fit to approach the first terminal fitting in a direction intersecting the first circuit board, and the second housing is formed with a supporting wall portion for receiving a pressing force at the time of fitting applied from the first terminal fitting to the second terminal fitting.

3. The connector device of claim 2, wherein:
the second housing is box-shaped to surround the first housing, and
a facing wall portion facing the second circuit board in the second housing is formed with a recess for exposing a connected part of the second board connecting portion to the second circuit board to outside of the second housing.

4. The connector device of claim 1, wherein:
the second terminal fitting is fit to approach the first terminal fitting in a direction intersecting the first circuit board,
the second board connecting portion is surface-mounted on the second circuit board, and
the second board connecting portion includes an extending portion projecting further toward the first circuit board than the second terminal connecting portion.

5. The connector device of claim 1, wherein:
a pair of the first terminal fittings are arranged side by side in parallel to the first circuit board,
the first board connecting portion includes a first bent portion having a quarter arc shape and extending from the first terminal connecting portion and a first mounting portion extending in parallel to the first circuit board from the first bent portion, and
extension directions of a pair of the first mounting portions are directions opposite to each other along an arrangement direction of the pair of first terminal fittings.

6. The connector device of claim 1, wherein:
a pair of the second terminal fittings are arranged side by side in parallel to the second circuit board,
the second board connecting portion includes a second bent portion having a quarter arc shape and extending from the second terminal connecting portion and a second mounting portion extending in parallel to the second circuit board from the second bent portion, and
extension directions of a pair of the second mounting portions are directions opposite to each other along an arrangement direction of the pair of second terminal fittings.

7. The connector device of claim 1 wherein:
the second terminal fitting is mounted by press-fitting the second terminal connecting portion into the second housing,
the second terminal connecting portion includes two folded and bent plate-like portions,
one of the two plate-like portions is linked to the second board connecting portion, and
a pressure receiving surface for receiving a pressing force for press-fitting the second terminal fitting into the second housing is formed on an end surface of the other of the two plate-like portions.
